(19) United States
(12) Patent Application Publication
(10) Pub. No.: US 2014/0057227 A1
(43) Pub. Date: Feb. 27, 2014

(54) SURGICAL TEMPLATE POSITIONING DEVICE

(71) Applicant: Taiwan Implant Technology Company, Kaohsiung City (TW)

(72) Inventors: Ying-lung CHENG, Kaohsiung City (TW); Hsiao-Ching WANG, Kaohsiung City (TW); Yi-Nung HO, Kaohsiung City (TW)

(21) Appl. No.: 13/904,044

(22) Filed: May 29, 2013

(30) Foreign Application Priority Data
Aug. 23, 2012 (TW) 101216286

(51) Int. Cl. A61C 8/00

(52) U.S. Cl. CPC A61C 8/009
USPC 433/173

(57) ABSTRACT

A surgical template positioning device, which comprises a template, a prosthetic tooth and a dental mold. The template has a first surface and a second surface, the first surface is formed with at least three spherical recesses and a guiding hole, relative positions of the spherical recesses define a triangle, and the guiding hole passes through the template. The prosthetic tooth has at least three spherical portions and one implanted hole, the spherical portions are combined with the spherical recesses of the first surface, and the guiding hole is corresponding to the implanted hole. The dental mold fixes the prosthetic tooth to a soft tissue between adjacent teeth. The present invention not only can save the manufacturing time and cost of the surgical template positioning device, but also is convenient to operate and exactly position, so as to increase the success rate of implanting surgery.

### FIELD OF THE INVENTION

The present invention relates to an artificial implant field, and more particularly to a surgical template positioning device having spherical recesses and spherical portions.

### BACKGROUND OF THE INVENTION

The tooth implant is a prosthetic tooth for substituting a whole tooth or a partial true tooth, and thus can solve the disadvantages that the traditional movable prosthetic tooth is not stably firmed or the bone matrix is shrank after many years. In the conventional implantation treatment, when the dentist performs an implant drilling surgery, the tooth implant is firstly designed based on a tooth computed tomography (CT) machine. Parameters during constructing a 3D model by scanning images can be collected to decide an ideal location, angle and depth of implanting, so as to correspondingly manufacture a surgical template positioning device.

However, even though the tooth computed tomography (CT) machine can provide an effective surgical simulated environment, such as effectively displaying the height and thickness of the alveolar bone and the actual distribution locations of nerves and blood vessels and exchanging different viewing angles for surveying the predefined position of tooth implant, it is still limited by the outline of the conventional positioning pins. When the positioning pins are not parallel to each other, it will not be able to accurately label the actual relative position to cause the parameter reading error, so as to manufacture a defective template. Although the dentist acquires such a template, the dentist is also difficult to further correct the template based on the actual situation of the oral cavity of the patient.

Because pre-operative assessment defect causes the deviation and dislocation of the drilling position, depth and angle, an artificial tooth implant can not be disposed on a pre-set position, and thus unnecessary complications and medical malpractice occur.

As a result, it is necessary to provide a surgical template positioning device to solve the problems existing in the conventional technologies, as described above.

### SUMMARY OF THE INVENTION

A primary object of the present invention is to provide a surgical template positioning device, which uses three non-collinear points to determine a plane, so as to actually response the oral cavity of the patient and reduce an inevitable deviation. Under the premise of controlling the coordination and symmetry of function and appearance, after reconstructing, it can achieve an expected ideal target.

A secondary object of the present invention is to provide a surgical template positioning device, which is not necessary to operate an extra puncture orientation to the gums of the patient, so as to reduce the discomfort in surgical process and then to save the manufacturing time and cost of the surgical template positioning device. Even the surgical template positioning device can be cooperated with a size-fixed sleeve to decrease the steps of replacing the template, so as to shorten the time in surgery.

To achieve the above object, the present invention provides a surgical template positioning device which comprises:

a template having a first surface and a second surface, wherein the first surface is formed with at least three spherical recesses and a guiding hole, relative positions of the spherical recesses define a triangle, and the guiding hole passes through the template;

a prosthetic tooth having at least three spherical portions and one implanted hole, wherein the spherical portions are combined with the spherical recesses of the first surface, and the guiding hole is corresponding to the implanted hole; and

a dental mold fixing the prosthetic tooth to a soft tissue between adjacent teeth.

In one embodiment of the present invention, the shape of the spherical recesses is complementary to the shape of the spherical portions.

In one embodiment of the present invention, the depth of the spherical portions is greater than a scanning span of a tooth computed tomography (CT) machine.

In one embodiment of the present invention, the guiding hole is vertical or tilted to the first surface of the template, and the guiding hole is vertical to the second surface of the template.

In one embodiment of the present invention, the diameter of the guiding hole is greater than or equal to an outer diameter of a drill sleeve, and the diameter of the implanted hole is greater than or equal to the diameter of the guiding hole.

To achieve the above object, the present invention further provides a surgical template positioning device which comprises:

a template having a first surface and a second surface, wherein the first surface has at least three spherical recesses and a guiding hole, relative positions of these spherical recesses define a triangle and the guiding hole passes through the template;

a prosthetic tooth having at least three cylindrical portions and an implanted hole, wherein each of top ends of the cylindrical portions has a spherical portion, the spherical portion is correspondingly combined with the spherical recess of the first surface, and the guiding hole is corresponding to the implanted hole; and

a dental mold fixing the prosthetic tooth to a soft tissue between adjacent teeth.

In another embodiment of the present invention, the shape of the spherical recesses is complementary to the shape of the spherical portions.

In another embodiment of the present invention, the depth of the spherical portion is greater than a scanning span of a tooth computed tomography (CT) machine.

In another embodiment of the present invention, the guiding hole is vertical or tilted to the first surface of the template, and the guiding hole is vertical to the second surface of the template.

In another embodiment of the present invention, the diameter of the guiding hole is greater than or equal to an outer diameter of a drill sleeve, and the diameter of the implanted hole is greater than or equal to the diameter of the guiding hole.

In comparison with the conventional techniques, the present invention provides to improve the poor practicability of the surgical template positioning device. Based on 3D reconstruction through a tooth computed tomography (CT) machine and accompanied with at least three spherical portions which are not collinear on a prosthetic tooth, the scanning data are collected and then the parameters of the curvature and radius are calculated to acquire the relative position of each spherical center for actually responding the status of the oral cavity of the patient, so as to manufacture an improved template. After that, the patient wears such customized template on the gums, the dentist conveniently uses the template to finish a tooth implanting surgery, which is used to effectively auto-drill on the edentulous portion of the alveolar bone to insert artificial tooth roots, so as to reduce the fault caused by the preoperative assessment. Therefore, it can certainly avoid from damaging the important nerves, blood vessels and organs in surgery, so as to significantly enhance the safety and the success rate of tooth implanting and also considerably reduce the discomfort of the patient in implanting process.

In regard to the feature and implementation of the present invention, preferred embodiment is in concert with figures to describe in detail hereinafter:

### DESCRIPTION OF THE DRAWINGS

FIG. 1 is a schematic view of a surgical template positioning device according to one embodiment of the present invention;

FIG. 2 is a cross-sectional view of the surgical template positioning device according to one embodiment of the present invention;

FIG. 3 is a schematic view of a first surface of the surgical template positioning device according to one embodiment of the present invention; and

FIG. 4 is a schematic view of the surgical template positioning device according to another embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, and etc., are only directions by referring to the accompanying drawings, and thus the used directional terms are used to describe and understand the present invention, but the present invention is not limited thereto.

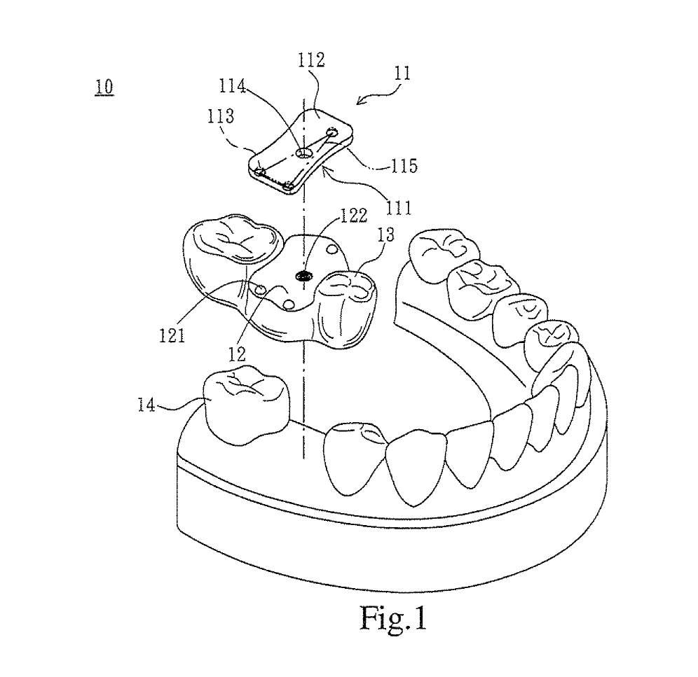

Referring to FIG. 1, a surgical template positioning device 10 according to one embodiment of the present invention is illustrated, wherein the surgical template positioning device 10 mainly comprises: a template 11, a prosthetic tooth 12 and a dental mold 13. The template 11 has a facing-down first surface 111 and a facing-up second surface 112, wherein the first surface 111 is formed with at least three spherical recesses 113 and a guiding hole 114, relative positions of the spherical recesses commonly define a triangle 115, and the guiding hole 114 passes through the template 11. The prosthetic tooth 12 has at least three spherical portions 121 and one implanted hole 122, wherein the spherical portions 121 are combined with the corresponding spherical recesses 113 of the first surface 111, and the guiding hole 114 is corresponding to the implanted hole 122. The dental mold 13 fixes the prosthetic tooth 12 to a soft tissue between adjacent teeth 14.

The present invention will describe the detail structures, the assembly relationship and operative principle of each foregoing element in the preferred embodiment more detailed according to FIGS. 1 to 4 hereinafter.

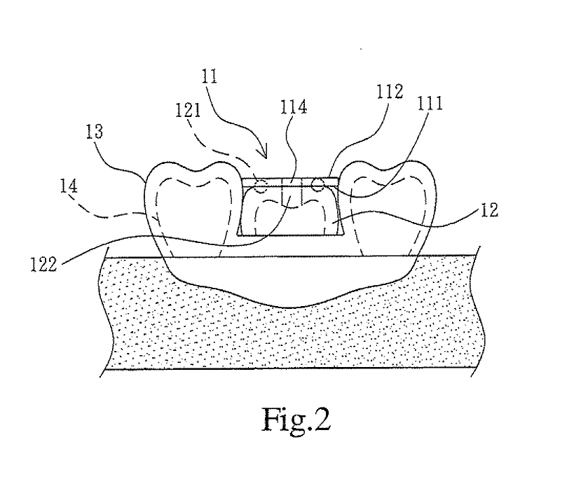

Referring to FIGS. 1 and 2, a schematic view of a surgical template positioning guide according to one embodiment of the present invention and a cross-sectional view of the surgical template positioning guide according to one embodiment of the present invention are illustrated. In comparison with the conventional cylindrical positioning pin members, the positioning member of the invention, that is, at least three spherical portions 121 formed as hemispherical-like structures and preferably use the materials having a high recognition, such as ceramic or zirconia having a high density feature. According to the high scanning resolution of a tooth computed tomography (CT) machine or an X-ray machine, 3D dimension of the oral cavity of the patient is virtually presented. The dentist is based on the outline of the spherical portions 121 and relative positions to operate 3D reconstruction. The present invention also can use portions of other shapes, such as elliptic, and the relative positions of the portions is calculated and analyzed by computing. It is worth noted that, the number of the spherical recesses 113 and the spherical portions 121 in the present invention also can be more than three (i.e. four, five, six or more) to certainly present 3D reconstruction.

3D reconstruction and the tooth implanting planning are further integrated and converted for molding a plaster mode (not shown) to represent the actual oral shape of the patient, comprising the features of teeth and soft tissues. Next, a thermoplastic resin and self-curing acrylic resin is used to cover the plaster mode to be a fixed shape, the residual portions of the edge are cut off and then a surface dental mold 13 is acquired. In particular, when the patient has a large area of edentulous regions, even complete edentulous, also can operate the surgery by matching the soft tissues with bone nails. The generation of a guiding hole and an implanted hole that the bone nail inserted into is the same as a guiding hole and an implanted hole of the artificial tooth implant, wherein the thermoplastic resin material can be resin, but not limited thereto.

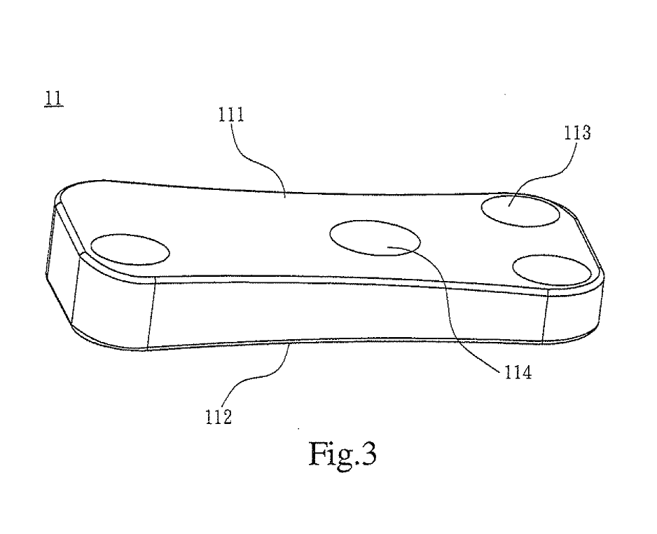

Referring to FIG. 3, a schematic view of a first surface 111 of the template 11 according to one embodiment of the present invention is illustrated. The spherical portions 121 are scanned by the tooth computed tomography (CT) machine to acquire a surface curvature, and then the surface curvature and the known radius are calculated to acquire the coordinate of a spherical center. Furthermore, the depth (the radius) of the spherical portions 121 is greater than a scanning span of the tooth CT, such as 2 mm or 3 mm, but not limited thereto. After that, the spherical recesses 113 are used to form with three non-collinear reference points, that is, the spherical centers of the spherical recesses 113 commonly determines a plane to form one 3D coordinate through the tooth computed tomography (CT) to produce the customized template 11, wherein the shape of the spherical recesses 113 is complemented to the shape of the spherical portions 121, so that the template 11 can tightly combine with the dental mold 13. In the embodiment, the spherical recesses 113 are not limited to hemispherical recesses of 180 degree, wherein a user also can adjust the degree thereof according to actual situation, such as to select arc spherical recesses having a degree smaller or greater than 180 degree.

After the template 11 is manufactured through a working machine, the template Ills then placed on the dental mold 13 for drilling the implanted hole 122 by a dental drill, wherein the guiding hole 114 are vertical to the first surface 111 and the second surface 112 of the template 11; or can be tilted to the first surface 111 of the template 11 and vertical to the second surface 112 of the template 11, wherein the first surface 111 of the template 11 is not parallel to the second surface 112. When the template 11 is placed on the prosthetic tooth 12, a dental drill is used to drill with a tilted angle. In one embodiment of the present invention, the inner diameter of the guiding hole 114 is greater than or equal to an outer diameter of a drill sleeve, and the inner diameter of the implanted hole 122 is greater than or equal to the inner diameter of the guiding hole 114.

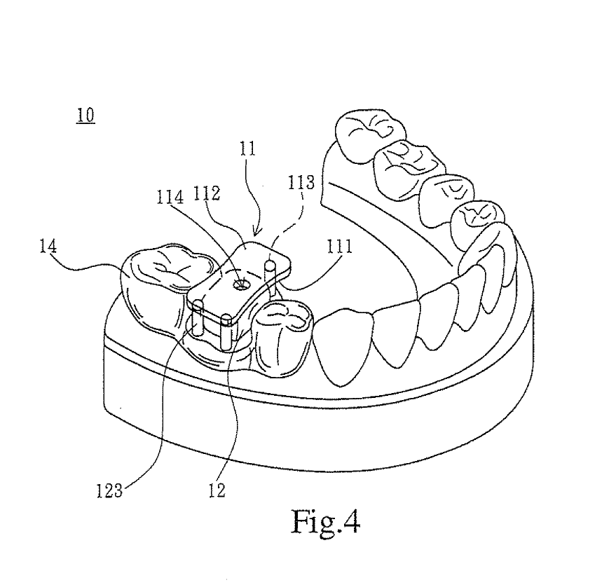

Referring to FIG. 4, a schematic view of a surgical template positioning device according to another embodiment of the present invention is illustrated and similar to the embodiment of FIG. 1, so that the second embodiment uses similar terms or numerals of the first embodiment. As shown, the surgical template positioning device 10 similarly comprises: a template 11, a prosthetic tooth 12 and a dental mold 13. The template 11 has a facing-down first surface 111 and a facing-up second surface 112, wherein the first surface 111 is formed with at least three spherical recesses 113 and a guiding hole 114, relative positions of the spherical recesses 113 commonly define a triangle 115, and the guiding hole 114 passes through the template 11. The prosthetic tooth 12 has at least three cylindrical portions 123 and one implanted hole 122, wherein each of top ends of the cylindrical portions 123 has a spherical portion (unlabeled), the spherical portion is correspondingly combined with the spherical recess 113 of the first surface 111, and the guiding hole 114 is corresponding to the implanted hole 122. The dental mold 13 fixes the prosthetic tooth 12 to a soft tissue between adjacent teeth 14. It is worth noted that, the number of the spherical recesses 113 and the cylindrical portions 123 of the present invention also can be more than three (i.e. four, five, six or more) to certainly present 3D reconstruction.

When the alveolar bone of the patient is defected, deformed or excessively tilted, under the premise of not cutting the gums to fill bone graft powder, the dentist can consider the oral cavity of the patient based on different requirement, so as to adjust at least three cylindrical portions 123 of the prosthetic tooth 12. Similarly, for exactly positioning, each of top ends of the cylindrical portions 123 has a spherical portion, so as to be advantageous to effectively drill a defined implanted hole at an actual position of the alveolar bone by a tool drill. The present invention also can use the cylindrical portions 123 having the spherical portions on the top ends thereof to cooperate with the spherical portions 121 of the prosthetic tooth 12 for achieving the same object.

As described above, in comparison with the conventional techniques, the present invention provides to improve the poor practicability of the surgical template positioning device. Based on 3D reconstruction through a tooth computed tomography (CT) machine and accompanied with at least three spherical portions 121 which are not collinear on the prosthetic tooth 12, the scanning data are collected, and then the parameters of the curvature and radius are calculated to acquire the relative position of each spherical center for actually responding the status of the oral cavity of the patient, so as to manufacture an improved template 11. After that, the patient wears such customized template 11 on the gums and, the dentist conveniently uses the template 11 to finish a tooth implanting surgery, which is used to effectively auto-drill on the edentulous portion of the alveolar bone to insert artificial tooth roots, so as to reduce the fault caused by the preoperative assessment. Therefore, it can certainly avoid from damaging the important nerves, blood vessels and organs in surgery, so as to significantly enhance the safety and the success rate of tooth implanting and also considerably reduce the discomfort of the patient in implanting process.

The present invention has been described with a preferred embodiment thereof and it is understood that many changes and modifications to the described embodiment can be carried out without departing from the scope and the spirit of the invention that is intended to be limited only by the appended claims.

What is claimed is:

1. A surgical template positioning device, comprising:
a template having a first surface and a second surface, wherein the first surface is formed with at least three spherical recesses and a guiding hole, relative positions of the spherical recesses define a triangle, and the guiding hole passes through the template;
a prosthetic tooth having at least three spherical portions and one implanted hole, wherein the spherical portions are combined with the spherical recesses of the first surface, and the guiding hole is corresponding to the implanted hole; and
a dental mold fixing the prosthetic tooth to a soft tissue between adjacent teeth.

2. The surgical template positioning device according to claim 1, wherein the shape of the spherical recesses is complementary to the shape of the spherical portions.

3. The surgical template positioning device according to claim 1, wherein the depth of the spherical portions is greater than a scanning span of a tooth computed tomography (CT) machine.

4. The surgical template positioning device according to claim 1, wherein the guiding hole is vertical or tilted to the first surface of the template, and the guiding hole is vertical to the second surface of the template.

5. The surgical template positioning device according to claim 1, wherein the diameter of the guiding hole is greater than or equal to an outer diameter of a drill sleeve, and the diameter of the implanted hole is greater than or equal to the diameter of the guiding hole.

6. A surgical template positioning device, comprising:
a template having a first surface and a second surface, wherein the first surface has at least three spherical recesses and a guiding hole, relative positions of these spherical recesses define a triangle and the guiding hole passes through the template;
a prosthetic tooth having at least three cylindrical portions and an implanted hole, wherein each of top ends of the cylindrical portions has a spherical portion, the spherical portion is correspondingly combined with the spherical recess of the first surface, and the guiding hole is corresponding to the implanted hole; and
a dental mold fixing the prosthetic tooth to a soft tissue between adjacent teeth.

7. The surgical template positioning device according to claim 6, wherein the shape of the spherical recesses is complementary to the shape of the spherical portions.

8. The surgical template positioning device according to claim 6, wherein the depth of the spherical portion is greater than a scanning span of a tooth computed tomography (CT) machine.

9. The surgical template positioning device according to claim 6, wherein the guiding hole is vertical or tilted to the first surface of the template, and the guiding hole is vertical to the second surface of the template.

10. The surgical template positioning device according to claim 6, wherein the diameter of the guiding hole is greater than or equal to an outer diameter of a drill sleeve, and the diameter of the implanted hole is greater than or equal to the diameter of the guiding hole.
